(19) United States
(12) Patent Application Publication
(10) Pub. No.: US 2022/0416464 A1
(43) Pub. Date: Dec. 29, 2022

(54) Electrical Outlet Covers and Related Methods

(71) Applicant: Johhannas Reyn, Mission Viejo, CA (US)

(72) Inventor: Johhannas Reyn, Mission Viejo, CA (US)

(21) Appl. No.: 17/304,782

(22) Filed: Jun. 25, 2021

(51) Int. Cl. H01R 13/447; H02G 3/08

(52) U.S. Cl. CPC H01R 13/447; H02G 3/085

(57) ABSTRACT

An electrical outlet cover includes a body portion resembling a body portion of a vertebrate or invertebrate creature. The body portion comprising a plurality of recesses and a plurality of couplers. One or more limbs and/or a head and/or a tail are configured to be removably coupled at the recesses and releasably secured thereto using one or more of the couplers. At least one of the recesses may not be coupled with a limb, head or tail, and may allow a cord of a plug, plugged into an electrical outlet covered by the electrical outlet cover, to extend through the recess. Through-holes or other mounting mechanisms are configured to allow mounting of the limbs with a wall such that the electrical outlet cover can be secured over the electrical outlet. In implementations the outlet cover cannot be removed, once secured to a wall, without unscrewing the legs from the wall.

### BACKGROUND

### 1. Technical Field

Aspects of this document relate generally to devices and methods for covering and/or protecting electrical outlet covers and/or protecting against electrical shock from electrical outlets.

### 2. Background Art

Some electrical outlet covers exist in the art. For example, some covers exist to protect outdoor electrical outlets from weather, such as rain and snow. Such outdoor covers can be closed while the outlet is not being used or while a plug is plugged into the outlet. In the case where a plug is plugged into the outlet while the cover is closed, an outdoor electrical outlet cover can protect the plug (and therefore the associated electrical device) from electrical issues due to moisture or the like contacting the prongs of the plug. Other devices exist for plugging into an outlet for protection, such as plastic devices configured to plug into outlets to prevent a child from being shocked by sticking a finger or other item within the outlet.

### SUMMARY

Implementations of electrical outlet covers may include a body portion resembling a body portion of a vertebrate or invertebrate creature. The body portion may include a plurality of recesses and a plurality of couplers. One or more limbs and/or a head and/or a tail may be configured to be removably coupled at the recesses and releasably secured thereto using one or more of the couplers. At least one of the recesses may not be coupled with a limb, head or tail, and may allow a cord of a plug, plugged into an electrical outlet covered by the electrical outlet cover, to extend through the recess. Through-holes or other mounting mechanisms may be configured to allow mounting of the limbs with a wall such that the electrical outlet cover can be secured over the electrical outlet. In implementations the outlet cover may not be removable, once secured to a wall, without unscrewing the legs from the wall.

General details of the above-described implementations, and other implementations, are given below in the DESCRIPTION, the DRAWINGS, and the CLAIMS.

### BRIEF DESCRIPTION OF THE DRAWINGS

Implementations will be discussed hereafter using reference to the included drawings, briefly described below, wherein like designations refer to like elements. The drawings are not necessarily drawn to scale.

FIG. 1 is a top-front perspective view of an implementation of an electrical outlet cover (cover);

FIG. 2 is a bottom-front perspective view of the cover of FIG. 1;

FIG. 3 is a top view of the cover of FIG. 1;

FIG. 4 is a top-rear perspective view of the cover of FIG. 1;

FIG. 5 is a left side view of the cover of FIG. 1;

FIG. 6 is a rear view of the cover of FIG. 1;

FIG. 7 is a right side view of the cover of FIG. 1;

FIG. 8 is a front view of the cover of FIG. 1;

FIG. 9 is a bottom view of the cover of FIG. 1;

FIG. 10 is a top-rear perspective view of a body portion of the cover of FIG. 1;

FIG. 11 shows a bottom-front perspective view of the body portion of FIG. 10;

FIG. 12 shows a bottom-rear perspective view of the body portion of FIG. 10;

FIG. 13 shows a right side view of a limb of the cover of FIG. 1;

FIG. 14 shows a top-front perspective view of the limb of FIG. 13;

FIG. 15 shows a bottom-rear perspective view of the limb of FIG. 13;

FIG. 16 shows a top-rear perspective view of a head of the cover of FIG. 1;

FIG. 17 shows a top-front perspective view of the head of FIG. 16;

FIG. 18 shows a bottom-front perspective view of the head of FIG. 16;

FIG. 19 shows a top-rear perspective view of a tail of the cover of FIG. 1;

FIG. 20 shows a top-front perspective view of the tail of FIG. 19;

FIG. 21 shows a bottom-front perspective view of the tail of FIG. 19;

FIG. 22 shows a top-rear perspective view of a body portion of a second implementation of an electrical outlet cover (second cover);

FIG. 23 shows a bottom-front perspective view of the body portion of FIG. 22;

FIG. 24 shows a bottom-rear perspective view of the body portion of FIG. 22;

FIG. 25 shows a right side view of a limb of the second cover;

FIG. 26 shows a top-front perspective view of the limb of FIG. 25;

FIG. 27 shows a bottom-rear perspective view of the limb of FIG. 25;

FIG. 28 shows a top-rear perspective view of a head of the second cover;

FIG. 29 shows a top-front perspective view of the head of FIG. 28;

FIG. 30 shows a bottom-front perspective view of the head of FIG. 28;

FIG. 31 shows a top-rear perspective view of a tail of the second cover;

FIG. 32 shows a top-front perspective view of the tail of FIG. 31; and

FIG. 33 shows a bottom-front perspective view of the tail of FIG. 31.

### DESCRIPTION

Implementations/embodiments disclosed herein (including those not expressly discussed in detail) are not limited to the particular components or procedures described herein. Additional or alternative components, assembly procedures, and/or methods of use consistent with the intended electrical outlet covers and related methods may be utilized in any implementation. This may include any materials, components, sub-components, methods, sub-methods, steps, and so forth.

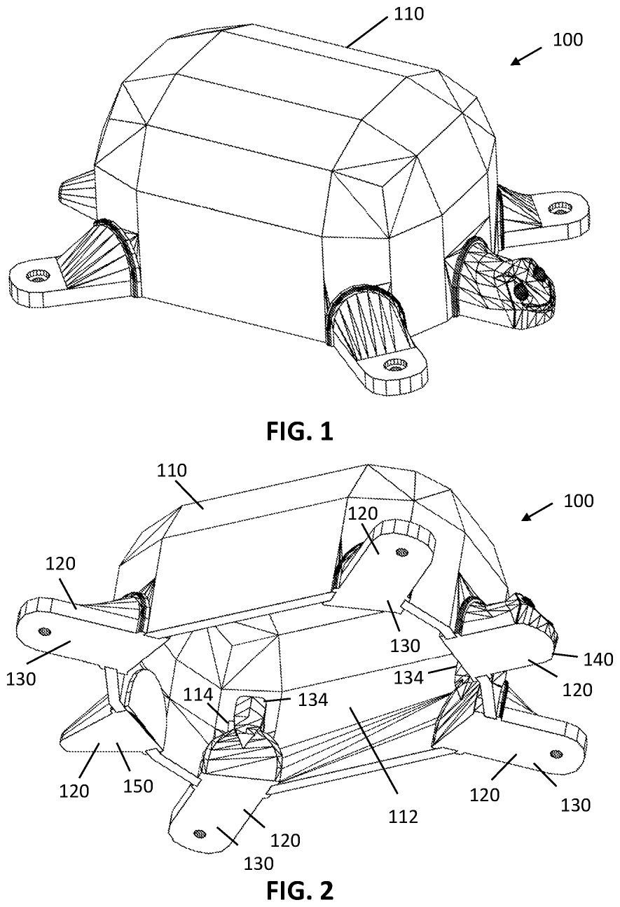

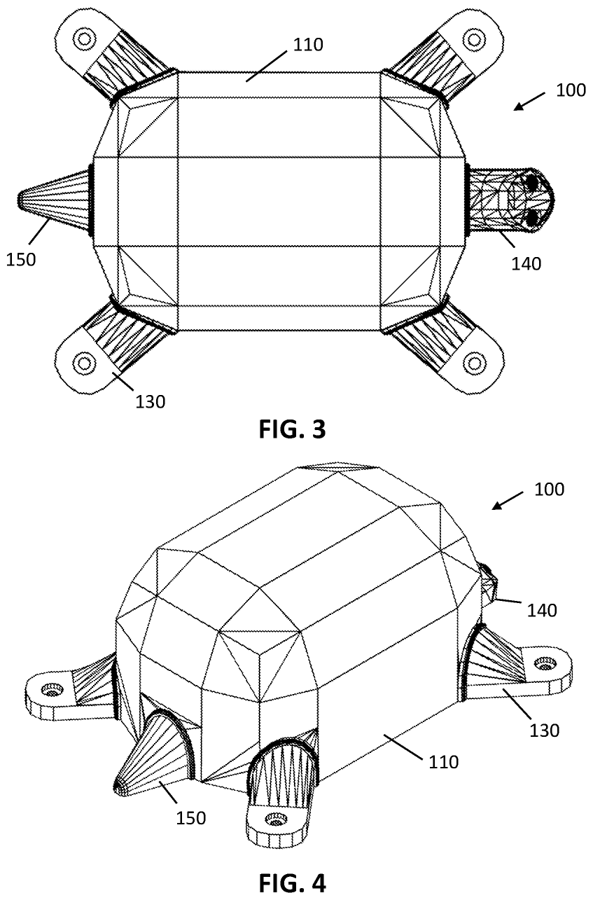

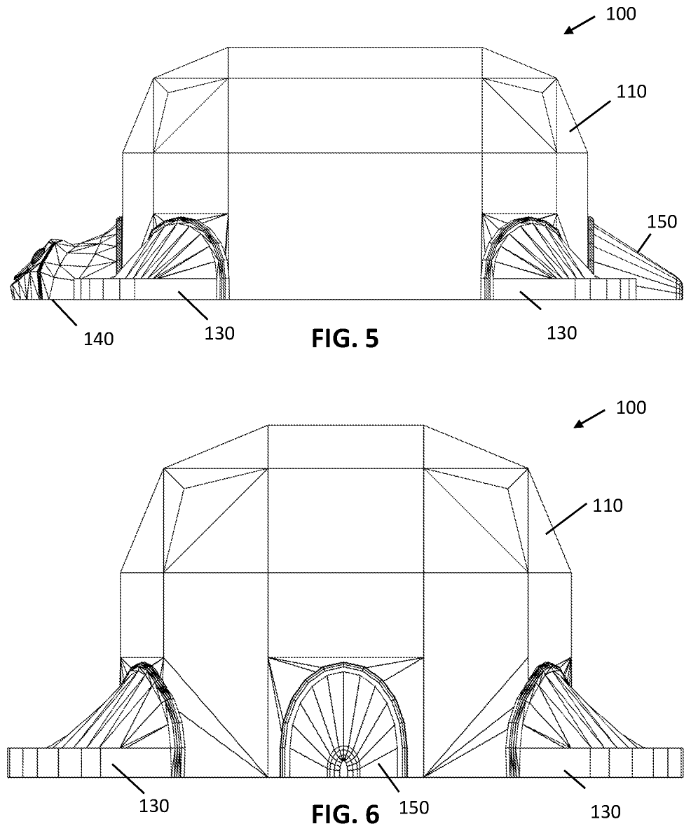

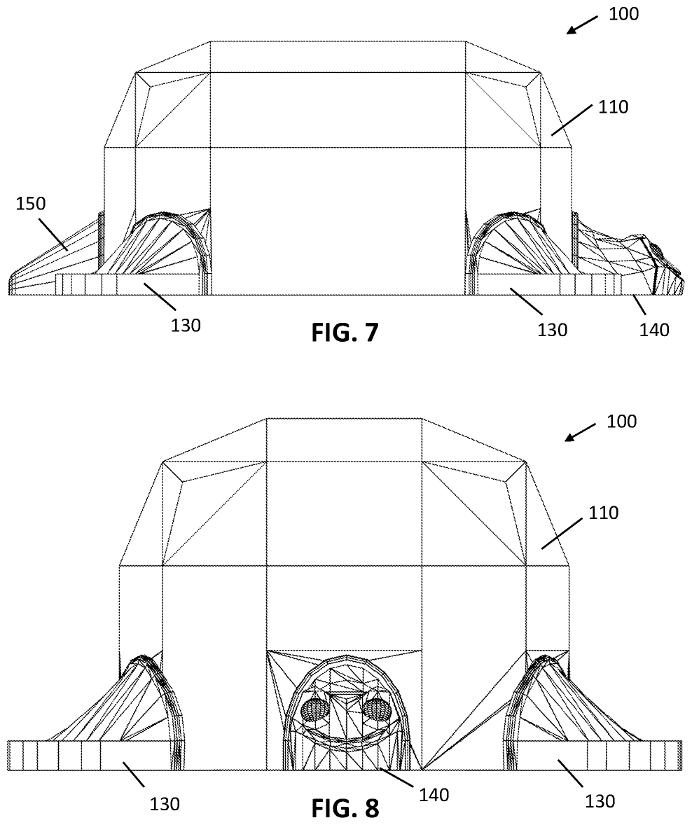

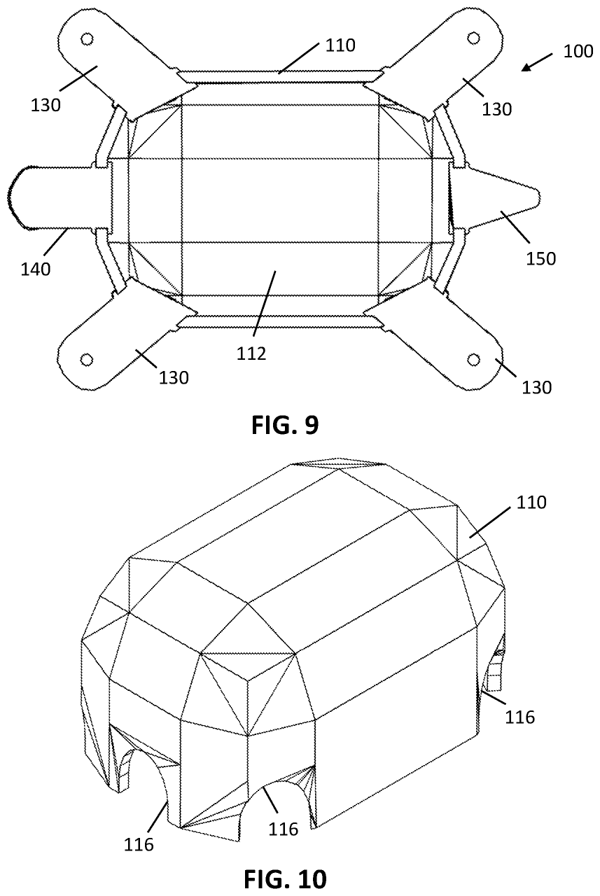

Referring now to FIGS. 1-9, various views of an implementation of an electrical outlet cover (cover) 100 are illustrated. FIG. 1 shows a front-top-right side view of the cover. FIG. 2 shows a front-bottom-right side view of the cover. FIG. 3 shows a top view of the cover. FIG. 4 shows a rear-top-right side view of the cover. FIG. 5 shows a left side view of the cover. FIG. 6 shows a rear view of the cover. FIG. 7 shows a right side view of the cover. FIG. 8 shows a front view of the cover. FIG. 9 shows a bottom view of the cover.

As can be seen, the cover has the shape of an animal (in this case a turtle) with a main body portion 110 and a number of appendages 120. The appendages include limbs 130, a head 140, and a tail 150. The term “limbs” as used herein is intended to include versions which only include feet and/or hands and not arms or legs, or arms/legs without feet, though in the implementation shown the limbs 130 include legs and feet.

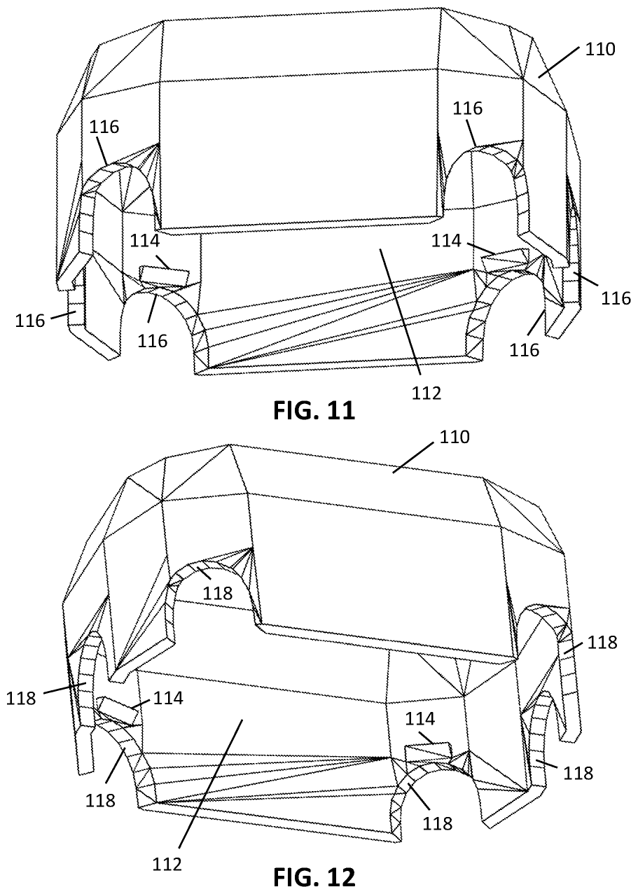

FIGS. 10-12 show different views of the main body portion, which in the case of the turtle version represents the shell of the turtle (though in the case of other animals it could simply be a torso or the like, or for example in the case of an insect or arachnid implementation the main body portion could be a thorax or other portion of an insect or arachnid body). In implementations it could resemble a body portion of any vertebrate or invertebrate creature. FIG. 10 shows a top-rear-right side view of the body portion 110. FIG. 11 shows a bottom-front-right side view of the body portion. FIG. 12 shows a bottom-front-left side view of the body portion.

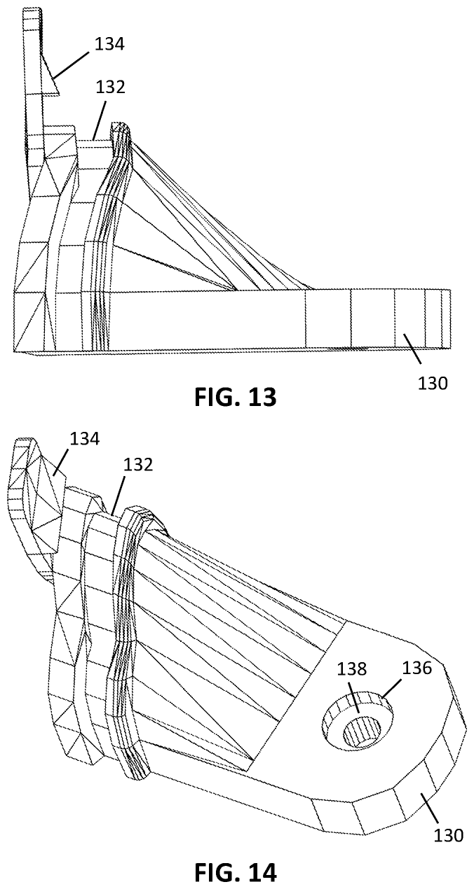

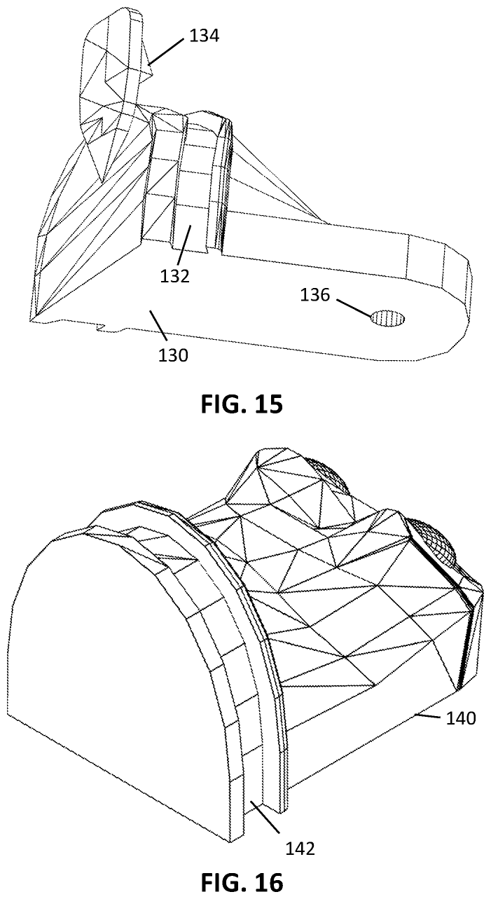

FIGS. 13-15 show different views of one of the limbs 130, specifically a front left foot of the turtle. FIG. 13 shows a right side view of the limb 130. FIG. 14 shows a top-front-right side view of the limb. FIG. 15 shows a bottom-rear-right side view of the limb.

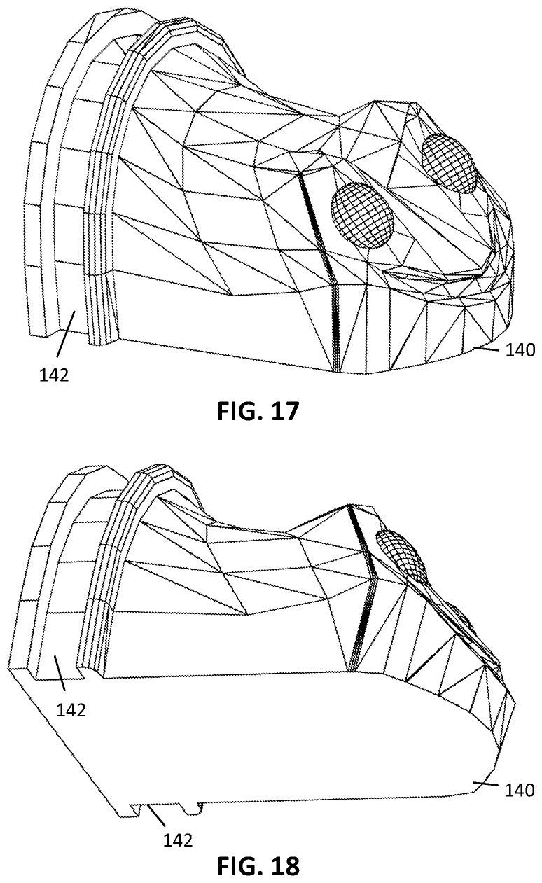

FIGS. 16-18 show different views of the head 140. FIG. 16 shows a top-rear-right side view of the head 140. FIG. 17 shows a top-front-right side view of the head. FIG. 18 shows a bottom-front-right side view of the head.

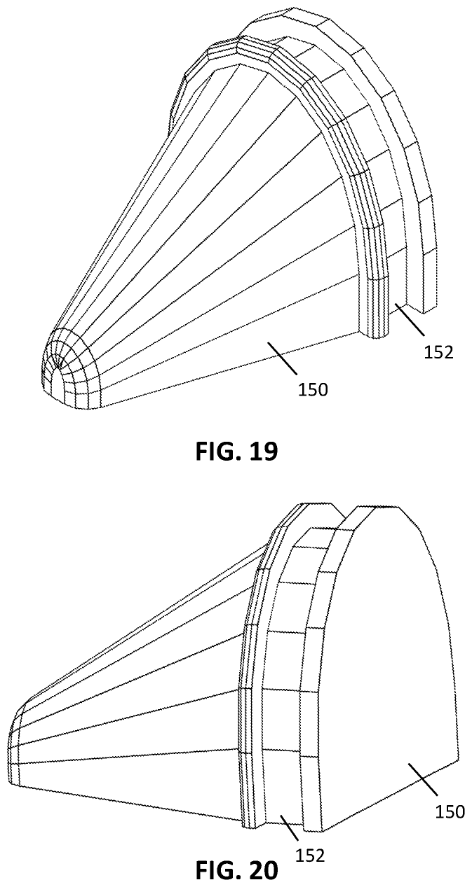

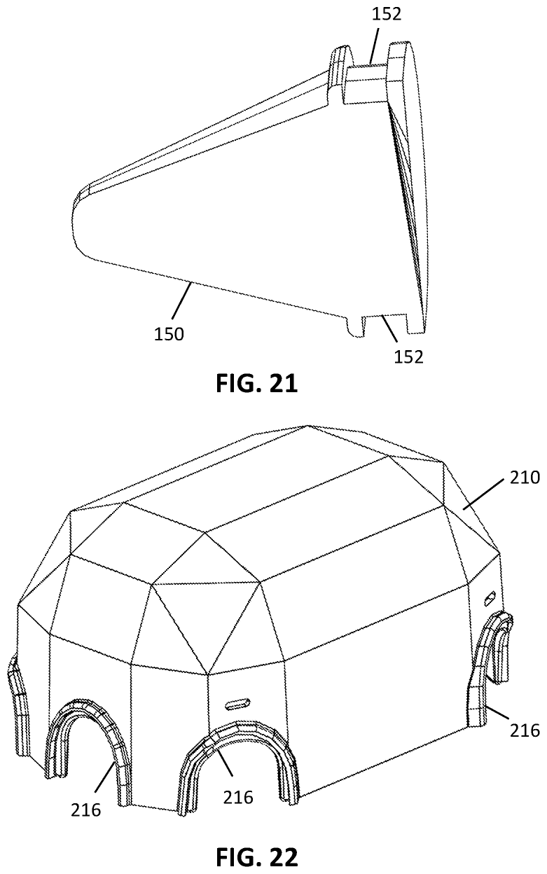

FIGS. 19-21 show different views of the tail 150. FIG. 19 shows a top-rear-right side view of the tail 150. FIG. 20 shows a top-front-right side view of the tail. FIG. 21 shows a bottom-front-right side view of the tail.

The various components of the electrical outlet cover make it useful for covering an electrical outlet while allowing a plug to still be plugged into the outlet. Each of the limbs 130 are shown to include a through-hole 136 which are useful for attaching the cover to a wall. In implementations this is a fixed attachment to the wall, for example standard 1.25 or 1.5 inch drywall screws could be inserted through the through-holes to fixedly attach the cover to the wall and over an electrical outlet. The drywall screws may be used with or without drywall anchors.

A fixed attachment such as this is useful in circumstances where it is desirable to provide a more permanent cover for the outlet. As a non-limiting example, an environment wherein an item needs to remain plugged in, but which includes small children or pets, may benefit from having covers 100 protecting the plugs from being unplugged. The cover may also protect children and pets from electrical shock, injury, and death. The cover can also be useful to prevent pets from chewing on a plug.

As can be seen from FIGS. 2, 9, 11 and 12, the body portion 110 includes a cavity 112 which is open to an underside of the body portion. When the cover is attached over an electrical outlet, the cavity allows sufficient room for one or more plugs to remain plugged into the electrical outlet. The cover could alternatively be used to cover an electrical outlet that has no plugs plugged into it, to protect children, other persons, or pets from contact with the outlet. For example, children sometimes place items like forks, knives, screwdrivers and the like into electrical outlets and are thereby shocked, injured, or even killed, and the cover may prevent such accidents. Preventing persons from tampering with the outlet may also protect the outlet itself and/or may prevent electrical shortages, electrical fires, and/or other damage/issues.

The cover shown in the drawings is not configured to allow a user to plug a plug into the outlet or unplug a plug from the outlet while the cover is attached to a wall. Rather, the user attaches the cover to the wall after one or more plugs are plugged into the outlet, so that the plug(s) remain plugged into the outlet while the cover is in place. If a user desires, thereafter, to unplug a plug from the outlet, or to plug a different electrical item in, the user first removes the cover from the wall, by removing the screws that attach it to the wall, and then may unplug the plugs and/or plug one or more different electrical items in.

The bottom of the body portion (and the bottoms of all attached appendages) are configured to be flush against the wall when the cover is attached to the wall. If an item is plugged into the outlet over which the cover is to be placed, one or more of the appendages may be removed before attaching the cover to the wall. FIGS. 10-12 show that the body portion includes a number of recesses/ports 116. Each of the recesses is defined by an edge 118. When any of the appendages is removed, the exposed recess/port allows for one or more cords to pass therethrough. Any of the appendages may be removed for this purpose. However, for stability, in some instances the user may desire to not remove more than one of the limbs, because the limbs attach the cover to the wall so that each removed limb removes an attachment point. If the user removes only the tail and/or head, all four attachment points remain. In some implementations, the user could remove two limbs and could leave the opposite-corner limbs to attach the cover to a wall. When a user removes the tail for the purpose of passing a cord through the tail recess, this has the added visual benefit of having the cord appear to be a tail of the animal/insect.

Referring to FIGS. 13-15, each of the limbs includes a slot 132 configured to receive the corresponding edge 118 of one of the recesses 116. Each of the limbs also includes a clip 134. The clip is configured to secure the limb to the body portion when the edge 118 is mated with the slot 132 and when the clip 134 is pushed past a protrusion 114 of the body portion to clasp thereto (protrusions 114 are shown in FIGS. 2 and 11-12 and are seen to be just above the recesses/ports that correspond to the limbs). This locking mechanism secures the body portion to the limb so that when the limbs are screwed into the wall, the body portion is not removable from the limbs. When the cover is not attached to a wall, however, a user may manually disengage the clip from the protrusion so that the limb can be slid off. The through-hole 136 is seen to be at least partly defined by a surface 138 that is inset from a top of the limb and which provides a resting place for a screw head, allowing the screw head to reside fully, or at least partly, within the through-hole itself.

Referring to FIGS. 16-18, the head includes a slot 142 configured to receive the corresponding edge 118 of one of the recesses 116. The head is configured to remain in place with a friction fit when the edge 118 is mated with the slot 142. Although there is no clip securing the head to the body portion, when the cover is attached to a wall the wall itself prevents the head from being removed. When the cover is not attached to a wall, however, a user may manually remove the head from the body portion.

Referring to FIGS. 19-21, the tail includes a slot 152 configured to receive the corresponding edge 118 of one of the recesses 116. The tail is configured to remain in place with a friction fit when the edge 118 is mated with the slot 152. Although there is no clip securing the tail to the body portion, when the cover is attached to a wall the wall itself prevents the tail from being removed. When the cover is not attached to a wall, however, a user may manually remove the tail from the body portion.

In some implementations the head and/or tail portions could also include through-holes for attaching to a wall. In some implementations the slots 142/152 and recesses 116 could all be identical so that a user could rearrange appendages as desired. In some implementations all appendages could include clips and the body portion could include a corresponding protrusion above each of the recesses/ports for locking purposes.

As described above, although the example of a turtle is given in the drawings, in other implementations other animal and/or insect designs could be used, each variation of which may include a body portion, a head, one or more limbs, and/or a tail. The animal/insect designs allow for a more aesthetically pleasing appearance than simply the view of the plugs and outlet. Other animal examples could be a bear, a lion, or a monkey, and insect examples could be an ant, a beetle, a fly, and so forth, as non-limiting examples—each having a body portion, a head, limbs, and in some cases a tail. For animals/insects without tails, the rear recess/port could mate with an appendage that acts as a part of the body portion, i.e., being relatively flush with the body portion, instead of protruding outward as a tail. For a bee version a stinger could be used instead of a tail. For some animals/insects there could be more appendages—for example an insect version could have six removable legs (and corresponding recesses/ports), or a spider version could have eight removable legs (and corresponding recesses/ports). Versions could be made for differently-sized outlets. For example the turtle version shown in the drawings may be useful for a two-plug outlet, whereas a larger turtle version, or a version with more legs and ports, may be useful for a four-plug outlet, a six-plug outlet, etc. Additional limbs and corresponding attachment points may be useful in implementations where 3 or more plugs may need to exit the cover through a recess/port (the recesses/ports made available by removing appendages and, in some cases, attachment points).

Although the cover is described as being used to cover an outlet, it could also be used to cover another item, such as a switch (a light switch or the like) which is desired to be kept in an on or an off position, the cover effectively preventing tampering with the switch.

The cover may include any colors and/or may have differently-colored portions, such as using paint/ink/dyes or the like. For example in the case of the turtle the shell may be a different color than the limbs, the eyes may include white and black paint, and so forth. The cover may be made of any materials. In some implementations all components of the cover are formed of a plastic or polymer, such as a molded plastic. In other implementations, however, the cover could be made of wood, of metal, of a composite, and so forth. The different components could also be made of different materials if desired. In implementations the body portion and/or other portions could be formed of a transparent or translucent material, and for example a night light or the like could be plugged into the outlet to shine through the cover. In some implementations the cover could have a built-in night light which plugs into one of the outlets, with the other outlet(s) being available to plug in other devices.

Although the cover could have any convenient size, the dimensions of the turtle version shown in the drawings are given below as a representative example:

Gross length: 9.5 in (24 cm)

Shell length: 6.75 in (16.5 cm)

Gross width: 6.75 in (16.5 cm)

Shell width: 4.5 in (11.5 cm)

Height: 3.625 in (9.2 cm)

The cavity of the shell (body portion) is 3.5 inches deep, 4.125 inches wide, and 6.125 inches long. This allows for oddly oversized plugs to fit easily into the inside of the shell/body portion.

Because the cover includes six available openings/ports for cords to go through (by removing various appendages) any orientation for the plug/cord can be accommodated.

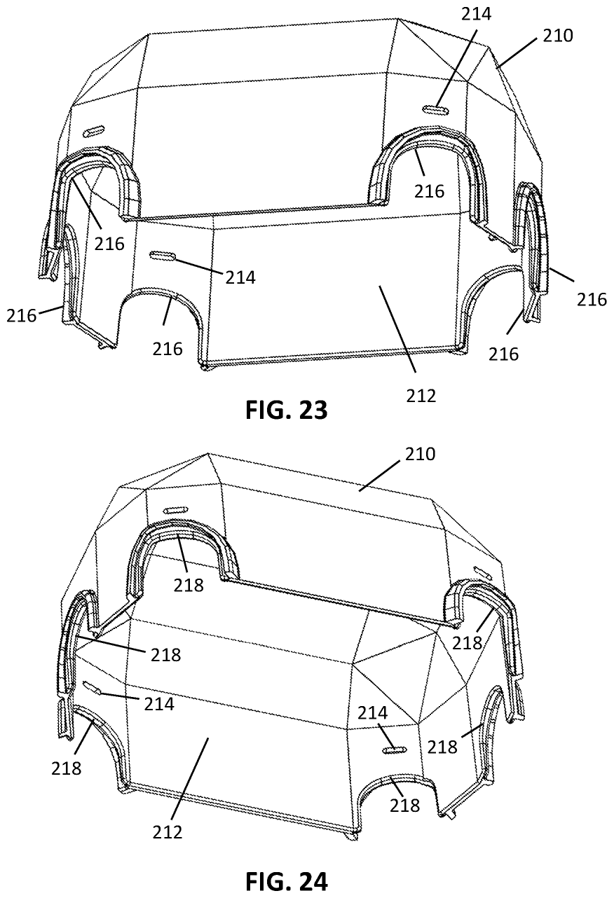

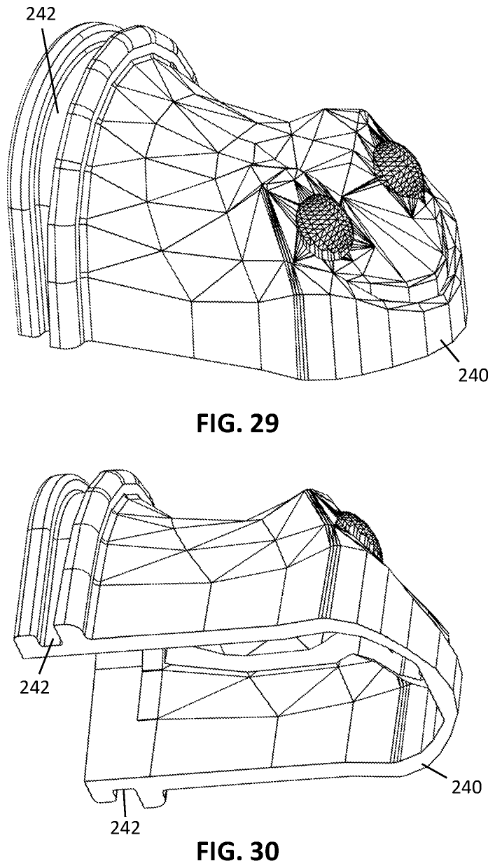

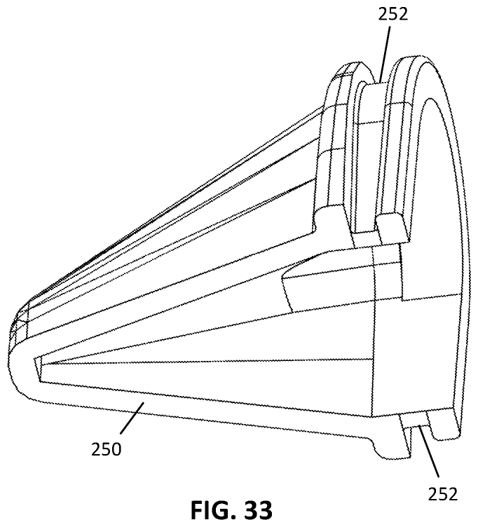

Referring now to FIGS. 22-33, elements of another version of an electrical outlet cover are shown. FIGS. 22-24 show views of a body portion 210 which in some ways is similar to body portion 110, including a cavity 212 and several recesses/ports 216 defining edges 218. Instead of protrusions for securing the limbs/head/tail, however, openings 214 are included. In some cases openings 214 could only be recesses on the inside of the body portion, not extending all the way through to the outside of the shell—but in FIGS. 22-24 the openings 214 extend all the way through the body portion. This version of an electrical outlet cover also includes appendages including limbs, a head, and a tail, which will be described below.

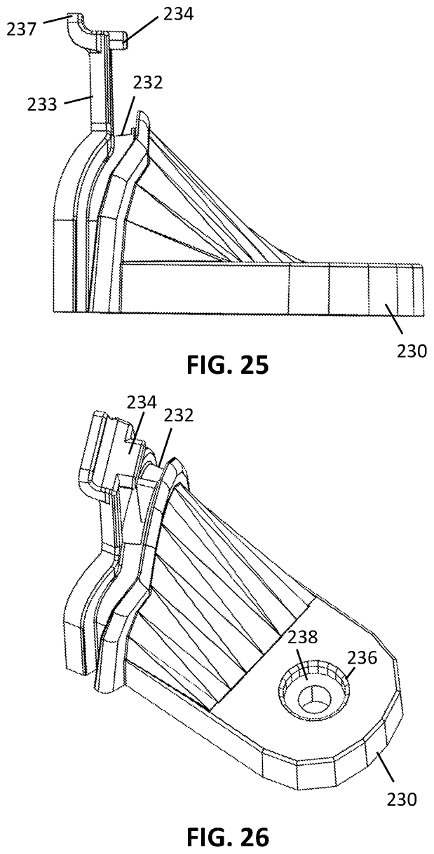

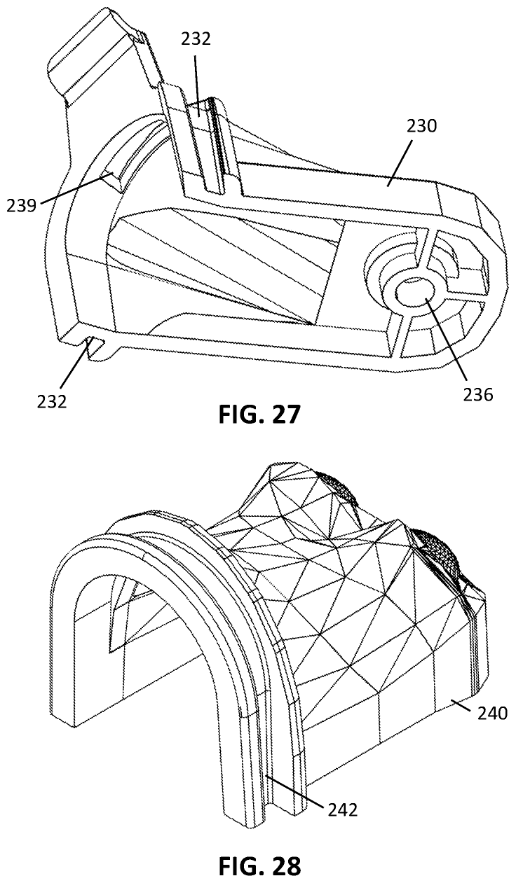

FIGS. 25-27 show views of a limb 230 which in some ways is similar to limb 130, including a slot 232, a through-hole 236, and a surface 238. Instead of a clip, however, a protrusion 234 is included. Protrusion 234 resides on an inner portion of an extension 233 that extends upward from a main portion of the limb, and is configured to pop into the opening 214 of the body portion automatically while the limb is being slid into the secured/attached configuration, and the user can manually pull a tab 237 of the limb away from the inner surface of the body portion, so that the protrusion exits the opening, in order be able to slide the limb away from the body portion to decouple it therefrom. Limb 230 is also seen to be generally hollow and to have a through-hole 239 proximate and underneath the protrusion (seen in FIG. 27). Naturally, in this implementation one limb will be identical to the limb shown in FIGS. 25-27 while other limbs will be mirror images of it.

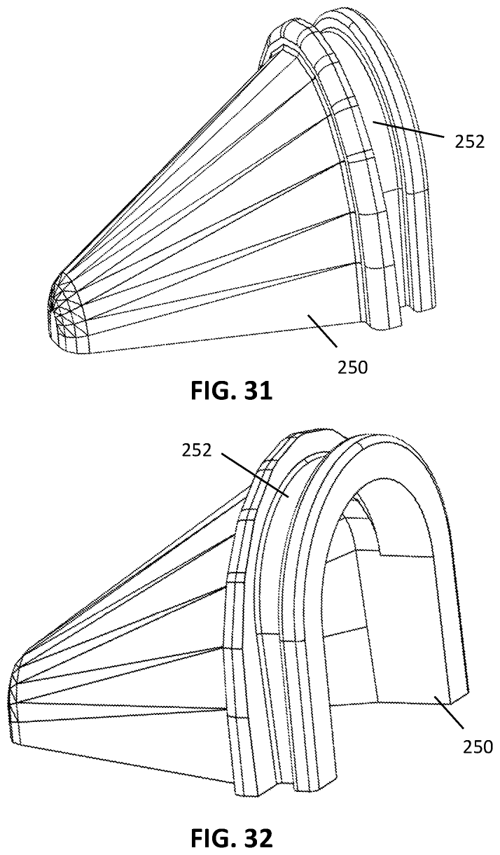

FIGS. 28-30 show views of a head 240 which in some ways is similar to head 140, including a slot 242. Head 240 is seen to be generally hollow. FIGS. 31-33 show views of a tail 250 which in some ways is similar to tail 150, including a slot 252. Tail 250 is seen to be generally hollow.

The clips 134, protrusions 114, protrusions 234 and openings 214 may each be called a coupler inasmuch as each helps to couple a limb with a body portion.

In places where the phrase “one of A and B” is used herein, including in the claims, wherein A and B are elements, the phrase shall have the meaning “A and/or B.” This shall be extrapolated to as many elements as are recited in this manner, for example the phrase “one of A, B, and C” shall mean “A, B, and/or C,” and so forth. To further clarify, the phrase “one of A, B, and C” would include implementations having: A only; B only; C only; A and B but not C; A and C but not B; B and C but not A; and A and B and C.

In places where the description above refers to specific implementations of electrical outlet covers and related methods, one or more or many modifications may be made without departing from the spirit and scope thereof. Details of any specific implementation/embodiment described herein may, wherever possible, be applied to any other specific implementation/embodiment described herein. The appended claims are to encompass within their scope all such changes and modifications as are within the true spirit and scope of this disclosure.

Furthermore, in the claims, if a specific number of an element is intended, such will be explicitly recited in the claim, and in the absence of such explicit recitation no such limitation exists. For example, the claims may include phrases such as “at least one” and “one or more” to introduce claim elements. The use of such phrases should not be construed to imply that the introduction of any other claim element by the indefinite article “a” or “an” limits that claim to only one such element, and the same holds true for the use in the claims of definite articles.

Additionally, in places where a claim below uses the term “first” as applied to an element, this does not imply that the claim requires a second (or more) of that element— if the claim does not explicitly recite a “second” of that element, the claim does not require a “second” of that element. Furthermore, in some cases a claim may recite a “second” or “third” or “fourth” (or so on) of an element, and this does not imply that the claim requires a first (or so on) of that element—if the claim does not explicitly recite a “first” (or so on) of that element, the claim does not require a “first” (or so on) of that element.

1. An electrical outlet cover, comprising:
a body portion resembling at least part of a body of a vertebrate or invertebrate creature, the body portion comprising a cavity sized to fully receive an electrical plug therein while the electrical plug is plugged into an electrical outlet and while the body portion is secured against a wall proximate the electrical outlet, the body portion further comprising a plurality of recesses and a plurality of couplers;
one or more appendages each configured to be coupled at one of the recesses, the one or more appendages comprising at least one of: one or more limbs each resembling a limb portion of the creature; a head resembling a head portion of the creature; and a tail resembling a tail portion of the creature;
wherein at least some of the appendages are configured to be secured to the body portion using at least some of the couplers;
wherein the body portion and the one or more appendages are configured to be combined to form an electrical outlet cover; and
wherein at least one of the recesses is sized and shaped such that when it has no appendage coupled thereat a cord of the electrical plug may extend from within the cavity through that recess to outside the cavity while the electrical plug is plugged into the electrical outlet and while the body portion is secured against the wall.

2. The electrical outlet cover of claim 1, wherein each of the recesses comprises an edge and wherein each of the appendages comprises a slot configured to receive one of the edges.

3. The electrical outlet cover of claim 1, wherein each of the couplers comprises a protrusion.

4. The electrical outlet cover of claim 3, wherein each of a subset of the appendages includes a clip configured to interact with one of the protrusions to secure the appendage to the body portion.

5. The electrical outlet cover of claim 1, wherein each of the couplers comprises an opening.

6. The electrical outlet cover of claim 5, wherein each of a subset of the appendages includes a protrusion configured to enter one of the openings to secure the appendage to the body portion.

7. The electrical outlet cover of claim 6, wherein each appendage which includes a protrusion further includes a tab configured to, with manual force, cause the protrusion to exit one of the openings such that the appendage may be removed from the body portion.

8. The electrical outlet cover of claim 1, wherein each of a subset of the appendages includes a through-hole configured to facilitate mounting the appendage to the wall using a screw.

9. The electrical outlet cover of claim 8, wherein each of the limbs includes a through-hole configured to facilitate mounting the limb to the wall using a screw.

10. The electrical outlet cover of claim 8, wherein the head and the tail do not include through-holes.

11. The electrical outlet cover of claim 1, wherein each of the recesses has an identical shape and an identical size such that any of the appendages may be coupled at any of the recesses and such that any of the recesses may be left without an appendage attached thereat to instead pass the electrical cord therethrough while the electrical plug is plugged into the electrical outlet and while the body portion is secured against the wall.

12. The electrical outlet cover of claim 1, wherein edges of the body portion are configured to contact the wall proximate the electrical outlet and at least partially circumscribe the electrical outlet while the electrical plug is plugged into the electrical outlet and while the cord extends from within the cavity to outside the cavity through one of the recesses.

13. An electrical outlet cover, comprising:
a body portion resembling at least part of a body of a vertebrate or invertebrate creature, the body portion comprising a cavity sized to fully receive an electrical plug therein while the electrical plug is plugged into an electrical outlet and while the body portion is secured against a wall proximate the electrical outlet, the body portion further comprising a plurality of recesses and a plurality of couplers;
one or more appendages each configured to be coupled at one of the recesses, the one or more appendages comprising:
one or more limbs each resembling a limb portion of the creature; and
one or more of:
a head resembling a head portion of the creature; and
a tail resembling a tail portion of the creature;
wherein the one or more limbs are configured to be secured to the body portion using at least some of the couplers;
wherein the body portion and the one or more appendages are configured to be combined to form an electrical outlet cover; and
wherein at least one of the recesses is sized and shaped such that when it has no appendage coupled thereat, a cord of the electrical plug may extend from within the cavity through that recess to outside the cavity while the electrical plug is plugged into the electrical outlet and while the body portion is secured against the wall.

14. The electrical outlet cover of claim 13, wherein each of the recesses comprises an edge and wherein each of the appendages comprises a slot configured to receive one of the edges.

15. The electrical outlet cover of claim 13, wherein each of the couplers comprises a protrusion, and wherein each of a subset of the appendages includes a clip configured to interact with one of the protrusions to secure the appendage to the body portion.

16. The electrical outlet cover of claim 13, wherein each of the couplers comprises an opening, and wherein each of a subset of the appendages includes a protrusion configured to enter one of the openings to secure the appendage to the body portion.

17. The electrical outlet cover of claim 13, wherein each of a subset of the appendages includes a through-hole configured to facilitate mounting of the appendage to the wall using a screw.

18. The electrical outlet cover of claim 13, wherein edges of the body portion are configured to contact the wall proximate the electrical outlet and at least partially circumscribe the electrical outlet while the electrical plug is plugged into the electrical outlet and while the cord extends from within the cavity to outside the cavity through one of the recesses.

19. A method of using an electrical outlet cover, comprising:
placing a body portion against a wall such that a cavity of the body portion fully receives an electrical plug therein while the electrical plug is plugged into an electrical outlet, the body portion resembling at least part of a body of a vertebrate or invertebrate creature, the body portion further comprising a plurality of recesses and a plurality of couplers;
coupling each of one or more appendages at one of the recesses, the one or more appendages comprising at least one of:
one or more limbs each resembling a limb portion of the creature;
a head resembling a head portion of the creature; and
a tail resembling a tail portion of the creature;
securing at least some of the appendages to the body portion using at least some of the couplers;
securing at least some of the appendages to the wall by screwing screws through through-holes of the appendages and into the wall;
wherein the body portion and the one or more appendages form an electrical outlet cover; and
positioning a cord of the electrical plug through one of the recesses which has no appendage coupled thereat such that the cord extends from within the cavity through that recess to outside the cavity while the electrical plug remains plugged into the electrical outlet.

20. The method of claim 19, further comprising exposing the electrical plug to be able to plug the electrical plug into the electrical outlet or unplug the electrical plug from the electrical outlet by one of: detaching the body portion from the appendages which are secured to the wall and distancing the body portion from the wall; and unscrewing the screws and distancing the body portion from the wall.
